(19) United States
(12) Patent Application Publication
(10) Pub. No.: US 2020/0394492 A1
(43) Pub. Date: Dec. 17, 2020

(54) Advanced ANN

(71) Applicant: Kevin Brian Delahoussaye, Las Cruces, NM (US)

(72) Inventor: Kevin Brian Delahoussaye, Las Cruces, NM (US)

(21) Appl. No.: 16/442,505

(22) Filed: Jun. 16, 2019

(51) Int. Cl. G06N 3/02

(52) U.S. Cl. CPC G06N 3/02

(57) ABSTRACT

Current ANN have a bias when computing data. Using this method of data analysis, we can solve that problem. Making sure that the Al must use keywords to quire information is a novel technique that allows for vast data analysis. Data analysis is the future of information technology. With the untold number of scientific literature among other types of literature analysis can be done to define patterns found throughout works and provide solutions.

### DETAILED DESCRIPTION OF THE INVENTION

A problem exists with current ANN in that they are not good enough. Some connections are weighted incorrectly and creates a solution bias. This eliminates the need for such a thing. Making sure that the Al must use keywords to quire information is a novel technique that allows for vast data analysis. Data analysis is the future of information technology. With the untold number of scientific literature among other types of literature analysis can be done to define patterns found throughout works and provide solutions. Looking at an item you can see it. This is because photons were absorbed/reflected by the atomic structure of the item. This item is a mathematical construction. The item is made up of atoms. When we see the photon, which is pure information at the basic level, the raw data is then transformed into another mathematical construction which is stored. This construction can be re-animated with electrical impulses. Think of a space filling model for an atom, this is on a much larger scale. this process of producing the image of the item is the principle of imagination. The brain is constantly rewiring and re-weighting the connections neurons have to each other to produce a better model of the world. Without being able to realize reality it is produces the need for this process.

### BRIEF SUMMARY OF THE INVENTION

Data analysis is the future of information technology. With the untold number of scientific literature among other types of literature analysis can be done to define patterns found throughout works and provide solutions. Data is stored as mathematical constructions/patterns. this allows for improved storage by condensing data into a structure Impulses propagated through a neuron/microchip/diamond reanimate this stored information. When recalling information this mathematical construction is a logical piece of a puzzle which is the problem to be solved.

Steps:

Partition your hard drive to the size you wish. You may need multiple drives with large disks.-Each partition will act as its own ANN. This eliminates the problem above.-Each partition is only accessed by the Al if keywords are used.-The Al must be programmed to respond to each partition, or category, of information by the keywords used above. You must be careful, or you will bias the results. When presented with a problem the Al can than search for keywords and identify patterns.-As the Al queries information, it will access the portioned drives and analyze the data.

These patterns are to be reinforced with a dopamine like code, when correct. Punishment if not.

I. Current ANN have a bias when computing data.

II: Using this method of data analysis, we can solve that problem. Making the Al must use keywords to quire information is a novel technique.

Ill: turning problems into mathematical constructions makes for easier problem solving.
